(19) United States
(12) Patent Application Publication
(10) Pub. No.: US 2018/0085840 A1
(43) Pub. Date: Mar. 29, 2018

(54) METHOD FOR CORRECTING PERPENDICULARITY OF ELECTRODE ROD FOR SUPER-DRILL DISCHARGE MACHINE

(71) Applicant: YJ CO., LTD., Bucheon-si, Gyeonggi-do (KR)

(72) Inventor: Chang Bok JEON, Incheon (KR)

(21) Appl. No.: 15/543,735

(22) PCT Filed: Jan. 12, 2016
(86) PCT No.: PCT/KR2016/000293

§ 371 Date: Oct. 20, 2017

(30) Foreign Application Priority Data
Jan. 14, 2015 (KR) 10-2015-0006794

(51) Int. Cl. B23H 7/26

(52) U.S. Cl. CPC B23H 7/26

(57) ABSTRACT

Provided is a method for correcting perpendicularity of an electrode rod for a super-drill discharge machine. The method is performed using a block with a truncated cone-shaped detection cavity and includes: finding a first center point of a circle on a first XY plane within the detection cavity; moving a tip of the electrode rod to the first center point; moving the electrode rod by a predetermined length (H) in a longitudinal direction thereof such that the tip of the electrode is disposed on a second XY plane; finding a second center point of a circle on the second XY plane; and calculating an inclination angle of the electrode rod by using a trigonometric function of a triangle in which the hypotenuse thereof is the predetermined length (H) and the adjacent side thereof is a distance from the tip of the electrode rod to the second center point on the second XY plane.

### TECHNICAL FIELD

The present invention relates to a method for correcting perpendicularity of an electrode rod for a super-drill electrical discharge machine. More particularly, the present invention is intended to correct a vertical position of an electrode rod by defining two XY planes each of which is delimited by the periphery of a detection cavity having a truncated cone shape and which have different sizes as being disposed in different positions in a vertical direction, obtaining a center point of a circle for each XY plane by detecting three points on the periphery of the corresponding XY plane; and calculating an inclination angle of the electrode rod by using a trigonometric function on the basis of the length of a hypotenuse and the length of an adjacent side of a triangle, which are acquired by obtaining the center points of the circles on the two XY planes.

### BACKGROUND ART

Generally, electrical discharge machines are classified into two types: a super-drill electrical discharge machine that forms a cavity or hole having a predetermined size in a work piece; and a wire electrical discharge machine that inserts a wire through the cavity or hole formed by the super-drill electrical discharge machine and further machines the work piece into a desired form. Patent documents 1 to 3 disclose technologies relating to a super-drill electrical discharge machine.

Patent document 1 relates to an electrode replacement apparatus for a super-drill electrical discharge machine. A head equipped with a super-drill is provided with an electrode replacing device, thereby reducing a time for replacing an electrode. Therefore, it is possible to improve work efficiency even in the case of machining a work piece having a complex structure.

Patent document 2 relates to a cooling device for a super-drill electrical discharge machine. The cooling device is structured to be inserted into and drawn out of the main body of the super-drill electrical discharge machine. Therefore, the overall volume of the super-drill electrical discharge machine is reduced. Since the cooling device (cooling water tank) is structured to be easily slid into and out of the main body, maintenance of the cooling device, such as replenishment of cooling water or removal of impurity, is facilitated.

Patent document 3 relates to the structure of a head of a super-drill electrical discharge machine and discloses a head for a super-drill electrical discharge machine having a biaxial rotation structure, in which a head equipped with a super-drill is rotatable in biaxial directions, i.e. leftward and rightward and forward and backward. An objective of this technology is to overcome the limitation in machining directions, thereby facilitating machining with respect to a work piece having a complex structure.

As illustrated in FIG. 1, a conventional super-drill electrical discharge machine includes a base 200 that supports a work piece W placed thereon and a head 100 that is mounted on the base 200 and structured to move over the work piece W in tri-axial directions (X, Y, and Z axes).

Specifically, the head 100 is mounted with an electrode rod 111 moving in the Z axis (up and down in the drawing) while maintaining a predetermined distance with respect to the work piece W. The electrode rod 111 is an element that actually performs electrical discharge machining. The electrode rod 111 is prepared in a predetermined length and is consumed while electrical discharge machining progresses. Therefore, as illustrated in FIG. 1, the electrode rod 111 is fitted in a guide 110 so as to perform reliable electrical discharge machining while maintaining a predetermined distance with respect to the work piece W.

Such a conventional super-drill electrical discharge machine has problems as described below.

(1) A super-drill electrical discharge machine usually forms a cavity or a hole extending in a perpendicular direction with respect to the surface of a work piece.

(2) For this reason, a guide needs to stably hold an electrode rod such that a lower portion of the electrode rod is arranged to be perpendicular to the work piece. However, it is actually difficult for the guide to hold the electrode rod such that the electrode rod is perpendicularly erected, which results in formation of a cavity or a hole that is not perpendicular to the work piece, thereby producing a defective product.

(3) This defect more frequently occurs when forming a small diameter cavity with a thin electrode rod.

(4) When electrical discharge machining is not perpendicularly performed with respect to a work piece, an operator needs to adjust an angle of a guide such that the electrode rod is perpendicularly arranged. In this case, since an operator checks the perpendicularity of the electrode rod by eye, it is difficult to precisely and accurately correct the perpendicularity of the electrode rod.

(5) Especially in the case in which precise machining is required to form a fine cavity or hole in a work piece, the poor precision in adjustment of the perpendicularity of the electrode rod is likely to result in a cavity or hole formed at a wrong position or a non-perpendicular cavity or hole.

(6) Accordingly, a technology for correcting the perpendicularity of an electrode rod such that electrical discharge machining can be performed in a substantially perpendicular direction with respect to a work piece is required.

(Patent Document 1) Korean Patent No. 1033186 (registered as of Apr. 28, 2011)

(Patent Document 2) Korean Patent No. 1075503 (registered as of Oct. 14, 2011)

(Patent Document 3) Korean Patent No. 1112495 (registered as of Jan. 30, 2012)

### DISCLOSURE

### Technical Problem

Accordingly, the present invention has been made keeping in mind the above problems occurring in the background art, and an objective of the present invention is to provide a method for correcting perpendicularity of an electrode rod for a super-drill electrical discharge machine, the method including: inserting a tip of the electrode rod into a detection cavity formed in a block, moving the electrode on first and second XY planes having different sizes as being disposed in different positions in a Z axis direction and as being delimited by the periphery of the detection cavity to obtain three points on the periphery of each XY plane, obtaining center points of circles each passing the three points on the corresponding XY plane, and calculating a trigonometric function using the center points of the circles, thereby correcting the perpendicularity of the electrode rod, whereby the method can correct the perpendicularity of the electrode rod using the block having a simple shape. In this way, it is possible to conveniently and automatically correct the perpendicularity of the electrode rod and to improve precision and accuracy of electrical discharge machining with respect to a work piece, resulting in a decrease in a defect production rate.

Specifically, the objective of the present invention is to provide the method for correcting perpendicularity of an electrode rod for a super-drill discharge machine, in which the detection cavity has a truncated cone shape tapering downward, so that even though the electrode rod, inclined with respect to a Z axis direction, is inserted into the detection cavity, there is low likelihood that the side surface of the electrode rod comes into contact with the inside surface of the detection cavity, thereby preventing the position of the electrode rod from being erroneously detected and ensuring precise and accurate correction of the position of the electrode rod.

### Technical Solution

In order to accomplish the objective of the present invention, there is provided a method for correcting perpendicularity of an electrode rod for a super-drill electrical discharge machine, the method being performed with respect to an electrode rod 111 mounted to a head 100 that moves in directions of three axes (X, Y, and Z axes), using a block 10 placed on a base 200 of the electrical discharge machine, the base 200 having a truncated cone-shaped detection cavity 11 that tapers downward and serving as a support for a work piece placed thereon, the method including: a first process of inserting a tip of the electrode rod 111 fitted in a guide 110 into the detection cavity 11; a second process of moving the electrode rod 111 on an XY plane 12 to obtain at least three points P1, P2, and P3 at which the tip of the electrode rod 111 meets an inside surface of the detection cavity 11, finding a first center point O of a first circle passing the at least three points P1, P2, and P3, and moving the tip of the electrode 111 to the first center point O; a third process of moving the electrode rod 111 by a predetermined length H in a longitudinal direction of the electrode rod 111 within the detection cavity 11; a fourth process of finding a second center point O′ of a second circle passing at least three points at which the tip of the electrode rod 111 meet the inside surface of the detection cavity 11 by moving the electrode rod 111 on an XY plane 12′; and a fifth step of calculating an inclination angle θ of the electrode rod 111 by using a trigonometric function of a triangle in which a hypotenuse thereof is the length H and an adjacent side thereof is a distance from the tip of the electrode rod 111 to the second center point O′, and correcting an angle of the electrode rod 111 by the calculated inclination angle by using the guide 110.

Specifically, in the third process, the electrode rod 111 may be moved deeper into the detection cavity 11.

Finally, in the fifth process, the angle is adjusted by using two linear motors or two servo motors arranged to cross each other.

### Advantageous Effects

The method for correcting the perpendicularity of an electrode rod for a super-drill electrical discharge machine according to the present invention has advantages described below.

(1) With the use of a block with a detection cavity, it is possible to easily correct the perpendicularity of an electrode rod by using a circle passing three points that are present on an XY plane delimited by the periphery of the detection cavity and at which the electrode rod installed to move in tri-axial directions (X, Y, and Z axes) meets the periphery of the detection cavity.

(2) Especially, since the perpendicularity correction of the electrode rod results in precise machining of a super-drill electrical discharge machine that is required to form a perpendicular cavity or hole in a work piece, the quality of finished work pieces is improved and a defect production rate is reduced.

(3) In addition, since it is possible to correct the perpendicularity of an electrode rod by using coordinates of positions of an electrode rod, which are obtained by simply adding a block having a detection cavity to a convention structure, it is possible to perform highly precise machining while minimizing the number of parts added.

(4) In addition, it is possible to automatically correct the perpendicularity of an electrode rod by automatically performing adjustment of an angle of a guide. Therefore, it is possible to reduce a processing preparation time for electrical discharge machining and an operation time of precise machining, thereby improving a production rate.

### DESCRIPTION OF DRAWINGS

FIG. 1 is a schematic view illustrating movement of a conventional head that forms a cavity or a hole in a work piece while moving in tri-axial directions (directions of X, Y, and Z axes), in a conventional an electrical discharge machine;

FIG. 2 is a perspective view illustrating the whole body of a block provided with a detection cavity, according to the present invention; and

FIGS. 3 to 5 are views sequentially illustrating a method for correcting the perpendicularity of an electrode rod, according to the present invention, wherein in each drawing, an upper part illustrates a cross-sectional view and a lower part illustrates a plan view of an XY plane.

### BEST MODE

Hereinbelow, a preferred embodiment of the present invention will be described with reference to the accompanying drawings in detail. All terms or words used in the specification and claims have the same meaning as commonly understood by one of ordinary skill in the art to which inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed.

(Structure)

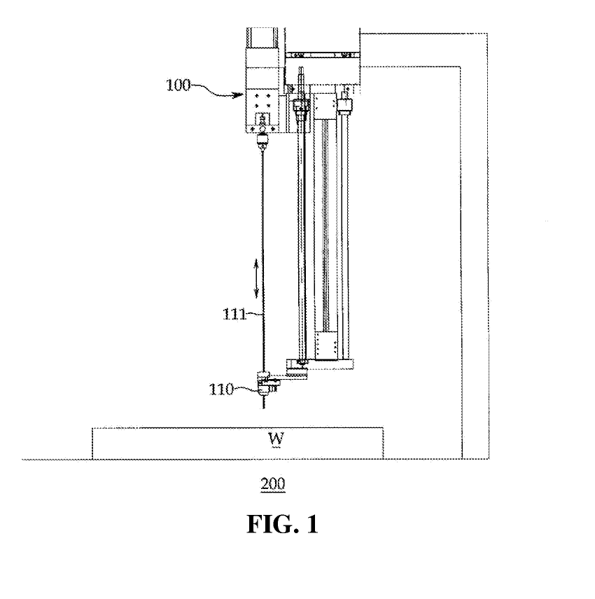

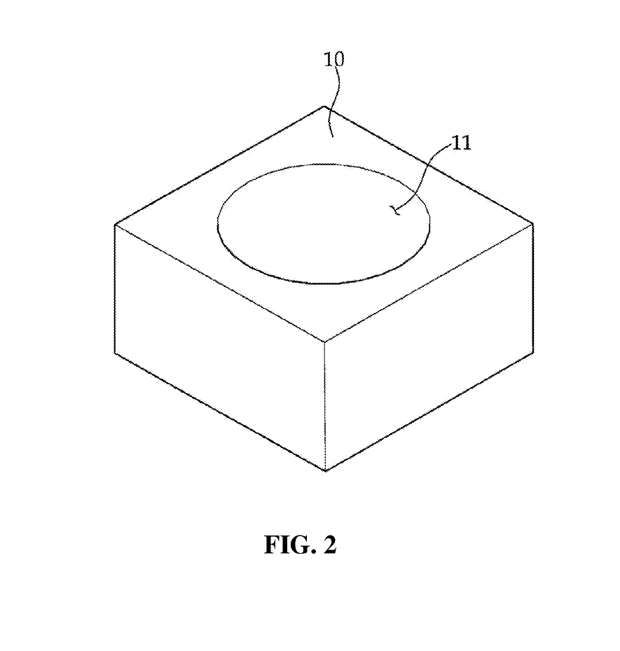

A method of correcting the perpendicularity of an electrode rod in a super-drill discharge machine, according to the present invention, is divided into five processes as illustrated in FIGS. 1 to 5. The processes will be sequentially described below.

As illustrated in FIG. 1, in a super-drill discharge machine, an electrode rod 111 is mounted to a head 100 that is installed to move in tri-axial directions (directions of X, Y, and Z axes) above a base 200 on which a work piece W is placed. The electrode rod 111 is manufactured using a conventional technology. A guide 110 is provided at a lower portion of the head 100 such that the electrode rod 111 is fitted in the guide 110. The guide 110 guides the electrode rod 111 to perform electrical discharge machining while maintaining a predetermined distance with respect to the work piece W.

A block 10 according to the present invention is provided with a detection cavity 11 tapering downward. The detection cavity 11 has a reverse truncated cone shape. When the tip of the electrode rod 111 disposed in the detection cavity 11 is moved, the tip of the electrode rod 111 is moved within a range of an imaginary circle having a predetermined diameter. In particular, it is preferable to prevent an outer surface of the electrode rod 111 from accidently coming into contact with the inside surface of the detection cavity 11 even when the electrode rod 111 is not perpendicular to a work piece.

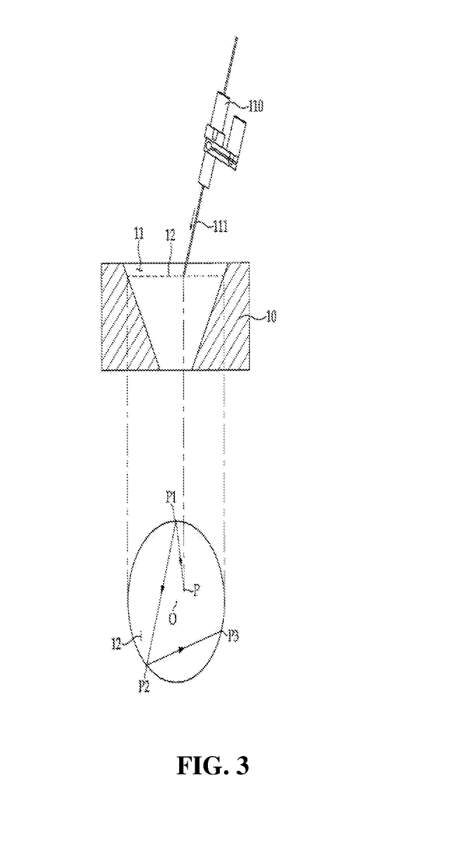

With reference to FIGS. 3 to 5, upper parts thereof are cross-sectional views of the block 110 and lower parts are plan views of an XY plane 12 within which the electrode rod 111 can move.

In a first process, as illustrated in FIG. 3, the tip of the electrode rod 111 is inserted into the detection cavity 11. At this time, the head is controlled such that the electrode rod 111 moves in an Z axis direction (up and down in the drawing). Optionally, the head may be controlled to move in an X axis direction and a Y axis direction (on a plane parallel to the base) as well as in the Z axis direction at the same time.

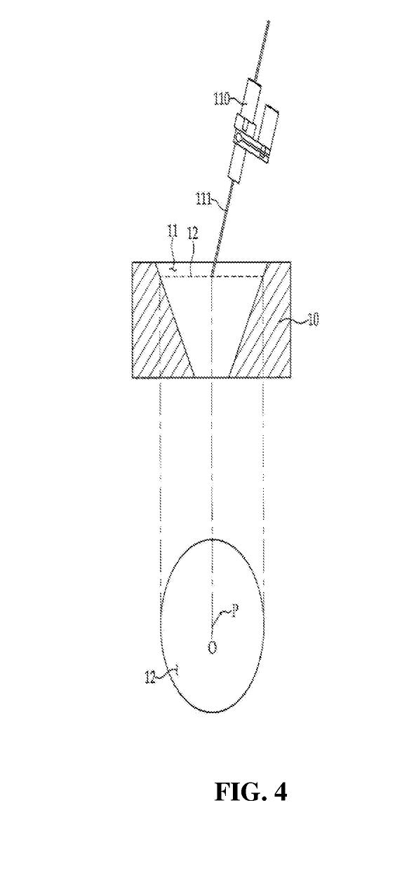

In a second process, as illustrated in FIGS. 3 and 4, a first center point O of an imaginary XY plane 12 is obtained and the tip of the electrode rod 111 is moved to the first center point O.

The XY plane 12 means an imaginary plane within which the electrode rod 111 is allowed to move. The electrode rod 111 is movable in tri-axial directions (directions of X, Y, and Z axes). However, usually, the electrode 111 is moved in biaxial directions (on an XY plane) while its position in the Z axis (position in the vertical direction) is fixed. The XY plane means a plane delimited by the periphery of the detection cavity 11.

The first center point O is the center of a circle passing three points P1, P2, and P3. The three points are obtained in such a manner that: the electrode rod 111 is moved in the X and Y axes directions until it reaches a point on the periphery of the XY plane 12 and the point is set as a first point P1; the electrode rod 111 is moved again on the XY plane 12 until it reaches another point on the periphery of the XY plane and the point is set as a second point P2; a third pint P3 is also set in a similar way.

Next, the center of the circle that passes these three points P1, P2, and P3 is obtained. The center is set as the first center point O. Then, as illustrated in FIGS. 3 and 4, the electrode rod 111 is moved from a point P to the first center point O.

In the preferred embodiment of the present invention, the first center point O is obtained by three points on a circle. However, those skilled in the art would appreciate that the first center point O can be obtained by using four or more points on a circle.

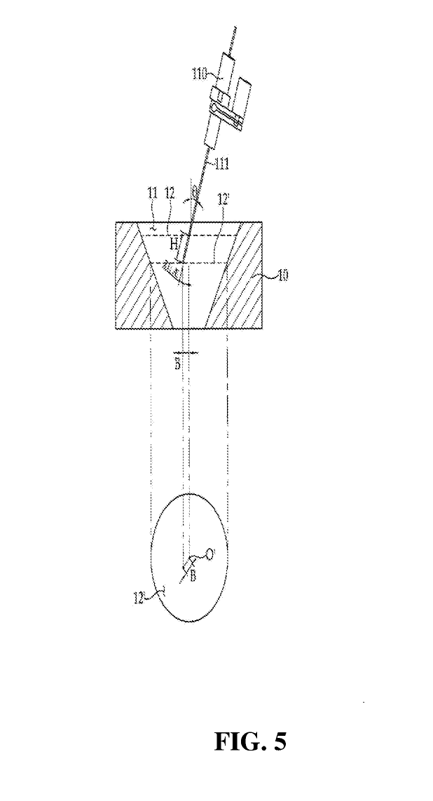

In a third process, as illustrated in FIG. 5, the electrode rod 111 is moved by a predetermined length H within the detection cavity 11. That is, the electrode rod 111 is guided by the guide 100 such that it is moved by the known length H in the longitudinal direction thereof.

In this case, the electrode rod 111 can be moved outward or deeper into in the detection cavity 11. However, it is preferable that the electrode rod 111 is moved deeper into the detection cavity 11 to prevent the tip of the electrode rod 111 from being disposed outside the detection cavity 11.

As illustrated in FIG. 5, a fourth process is a process of obtaining a second center point O′ by moving the electrode rod 111. This process is performed in the same way as in the second process of obtaining the first center point O using the three-point detection method.

In the fourth process, however, the position of an XY plane 12′ used to detect three points in this process is different from the position of the XY plane used in the second process, in terms of the vertical direction. That is, since the electrode rod 111 is moved deeper into the detection cavity 11, the size of the XY plane 12′ is reduced as compared with the XY plane 12. However, the method of obtaining the center point is the same as that of the second process.

In a fifth process, as illustrated in FIG. 5, an angle of the guide 110 is adjusted such that the electrode rod 111 is arranged to be perpendicular to a work piece. An adjustment angle of the guide 110 is calculated using a trigonometric function based on the length H and a distance from the position of the tip of the electrode rod to the second center point O′ on the XY plane 12′.

That is, when a trigonometric function is applied to a right triangle in which a hypotenuse thereof is the length H by which the electrode rod 111 is moved in the third process and an adjacent side B thereof is a distance from the tip of the electrode 111 to the second center point O′ on the XY plane 12′, an included angle θ between the hypotenuse and the adjacent side of the right triangle can be calculated.

The angle of the guide 110 is adjusted by the value of the calculated angle so that the perpendicularity of the electrode rod 111 can be corrected. At this time, the correction is performed by moving the guide 10 using two linear motors or two servo motors arranged to cross each other.

In FIG. 5, the length of the adjacent side B in the cross-sectional view of the block 10 appears to be different from the length of the adjacent side B on the plan view of the XY plan 12′ because the adjacent side marked on the block 10 is viewed from one side of the XY plane 12′. However, the lengths in both the views are actually the same. An arrow in the drawing shows a path along which the tip of the electrode rod 111 is moved.

As described above, according to the present invention, it is possible to easily and promptly correct the perpendicularity of the electrode rod using the detection cavity. Therefore, it is possible to precisely form a perpendicular cavity or hole.

### DESCRIPTION OF THE REFERENCE NUMERALS IN THE DRAWINGS

10: Block
11: Detection cavity
12, 12′: XY plane
110: Guide
111: Electrode rod

1. A method for correcting perpendicularity of an electrode rod for a super-drill electrical discharge machine, the method being performed with respect to an electrode rod (111) mounted to a head (100) that moves in directions of three axes (X, Y, and Z axes), using a block (10) placed on a base (200) of the electrical discharge machine, the base (200) having a truncated cone-shaped detection cavity (11) that tapers downward and serving as a support for a work piece placed thereon, the method comprising:
a first process of inserting a tip of the electrode rod (111) fitted in a guide (110) into the detection cavity (11);
a second process of moving the electrode rod (111) on an XY plane (12) to obtain at least three points (P1, P2, and P3) at which the tip of the electrode rod (111) meets an inside surface of the detection cavity (11), finding a first center point (0) of a first circle passing the at least three points (P1, P2, and P3), and moving the tip of the electrode (111) to the first center point (O);
a third process of moving the electrode rod (111) by a predetermined length (H) in a longitudinal direction of the electrode rod (111) within the detection cavity (11);
a fourth process of finding a second center point (O′) of a second circle passing at least three points at which the tip of the electrode rod (111) meet the inside surface of the detection cavity (11) by moving the electrode rod (111) on an XY plane (12′); and
a fifth step of calculating an inclination angle (θ) of the electrode rod (111) by using a trigonometric function of a triangle in which a hypotenuse thereof is the length (H) and an adjacent side thereof is a distance from the tip of the electrode rod (111) to the second center point (O′), and correcting an angle of the electrode rod (111) by the calculated inclination angle by using the guide (110).

2. The method according to claim 1, wherein in the third process, the electrode rod (111) is moved deeper into the detection cavity (11).

3. The method according to claim 1, wherein in the fifth process, the angle is adjusted by using two linear motors or two servo motors arranged to cross each other.

4. The method according to claim 2, wherein in the fifth process, the angle is adjusted by using two linear motors or two servo motors arranged to cross each other.
